(19) United States
(12) Patent Application Publication
(10) Pub. No.: US 2016/0190591 A1
(43) Pub. Date: Jun. 30, 2016

(54) LITHIUM-ION SECONDARY BATTERY AND PREPARATION METHOD THEREOF

(71) Applicant: Dongguan Amperex Technology Limited, Dongguan City (CN)

(72) Inventors: Hongguang SHEN, Dongguan City (CN); Xiaowen ZHANG, Dongguan City (CN); Zhanzhao FANG, Dongguan City (CN); Shaojun NIU, Dongguan City (CN); Dongming HE, Dongguan City (CN)

(73) Assignee: Dongguan Amperex Technology Limited, Dongguan City (CN)

(21) Appl. No.: 14/971,816

(22) Filed: Dec. 16, 2015

(30) Foreign Application Priority Data
Dec. 29, 2014 (CN) 201410835710.6

(51) Int. Cl. H01M 4/62; H01M 10/058; H01M 10/0525

(52) U.S. Cl. CPC H01M 4/622; H01M 10/0525; H01M 10/058

(57) ABSTRACT

The present application discloses a lithium-ion secondary battery. By using an adhesive containing an active group in a positive electrode and/or a negative electrode, and using a coupling agent solution containing an amino or epoxy group to treat the surface of a separator, an interface between the separator and an electrode react chemically to be connected with a covalent bond, thus improving the deformation of the lithium-ion secondary battery during a cycle.

### TECHNICAL FIELD

The invention relates to the technical field of lithium-ion batteries.

### BACKGROUND

Due to its high energy density, long service life, environmental protection and other features, a lithium-ion battery has been widely used in a mobile phone, a laptop computer, a digital camera and other consumer electronics products, and may be used in an electric car in the near future.

With the expanding range of applications, the market also puts forward higher requirements for the performance of the lithium-ion battery, especially with the popularity of a smart phone, the demand for the lithium-ion battery with no-deformation higher energy density is increased.

### SUMMARY OF THE INVENTION

According to one aspect of the present application, a lithium-ion secondary battery is provided. By using an adhesive containing an active group in a positive electrode and/or a negative electrode, and using a coupling agent solution containing an amino or epoxy group to treat the surface of a separator, an interface between the separator and an electrode react chemically to be connected with a covalent bond, thus improving the deformation of the lithium-ion secondary battery during cycling.

The lithium-ion secondary battery includes a positive electrode, a negative electrode, a separator and an electrolyte, wherein, the positive electrode and/or the negative electrode contain therein an adhesive, the separator and the adhesive are connected by a coupling agent with a covalent bond; the coupling agent contains an epoxy group and/or amino group; the adhesive contains a polymer, and the structural formula of at least one of monomers forming the polymer contains the group shown in Formula I:

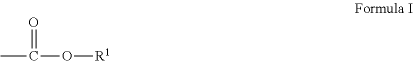

in which, R¹ is hydrogen or R¹ is selected from a hydrocarbyl group having 1 to 20 carbon atoms or R¹ is selected from a group having 1 to 20 carbon atoms and containing at least one of a hydroxyl, a cyano group, a ketone group, an aldehyde group, a phenolic group, and an epoxy group.

Preferably, the coupling agent is selected from at least one of a silane coupling agent, a titanate coupling agent, and an aluminate coupling agent. Further preferably, the coupling agent is selected from at least one of silane coupling agents.

Preferably, the coupling agent is selected from at least one of 2-(3,4-epoxycyclohexyl)ethyltrimethoxysilane, 3-glycidoxypropyltrimethoxysilane, 3-glycidoxypropylmethyldiethoxy silane, 3-glycidoxypropyltriethoxysilane, N-2-(aminoethyl)-3-aminopropylmethyl dimethoxysilane, N-2-(aminoethyl)-3-aminopropyltrimethoxysilane, 3-aminopropyl trimethoxysilane, 3-aminopropyltriethoxysilane, and N-phenyl-3-aminopropyl trimethoxysilane. Preferably, the adhesive contains therein a polymer, and at least one of the monomers forming the polymer has the structural formula shown in Formula II:

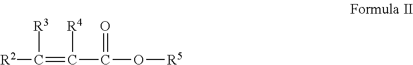

in which, R² is hydrogen or R² is selected from an alkyl having 1 to 20 carbon atoms; R³ is hydrogen or R³ is selected from an alkyl having 1 to 20 carbon atoms; R⁴ is hydrogen or a cyano group or R⁴ is selected from an alkyl having 1 to 20 carbon atoms; R⁵ is hydrogen or R⁵ is selected from an alkyl having 1 to 20 carbon atoms or R⁵ is selected from a group having 1 to 20 carbon atoms and containing at least one of a hydroxyl group, an amino group and an epoxy group.

Preferably, in Formula II, R² is hydrogen or R² is selected from an alkyl having 1 to 4 carbon atoms; R³ is hydrogen or R³ is selected from an alkyl having 1 to 4 carbon atoms. Further preferably, R² and R³ in Formula II are both hydrogen.

Preferably, in Formula II, R⁴ is hydrogen or a cyano group or R⁴ is selected from an alkyl having 1 to 4 carbon atoms.

Preferably, in Formula II, R⁵ is hydrogen or R⁵ is selected from an alkyl having 1 to 14 carbon atoms or R⁵ is selected from a group having 1 to 14 carbon atoms and containing at least one of a hydroxyl, an amino and an epoxy group. Further preferably, R⁵ in Formula II is hydrogen.

Preferably, the monomer with the structural formula shown in Formula II is selected from at least one of an acrylic acid, a methacrylic acid, a methylacrylate, a methylmethacrylate, an ethylacrylate, an ethylmethacrylate, a n-butylacrylate, an octylacrylate, a decylacrylate, a laurylacrylate, an isopropylacrylate, a butylmethacrylate, a hydroxymethylmethacrylate, a hydroxyethylmethacrylate, a hydroxypropylmethacrylate, a hydroxybutylmethacrylate, a hydroxypropylacrylate, a glycoldimethacrylate, a dodecylmethacrylate, a glycidyl methacrylate, an aminoethylacrylate, a butylcyanoacrylate, a hexylcyanoacrylate, and a heptylcyanoacrylate.

Preferably, the adhesive contains a polymer which is obtained from acrylate monomers and/or acrylic monomers by an emulsion polymerization method or a solution polymerization method. In the adhesive, the molecular weight of the polymer is within a range of 300 thousand-1.2 million.

The acrylic monomer has the structural formula shown in Formula II, and R² is hydrogen and R⁵ is hydrogen.

The acrylic monomer has the structural formula shown in Formula II, and R² is hydrogen, R⁵ is selected from an alkyl having 1 to 20 carbon atoms or R⁵ is selected from a group having 1 to 20 carbon atoms and containing at least one of a hydroxyl group, an amino group and an epoxy group.

Preferably, the adhesive contains a polymer, and in addition to the monomer with the structural formula shown in Formula II, the monomer forming the polymer may also contain at least one of an acrylonitrile, a butadiene, a methacrylonitrile, an acrylamide, a methacrylamide, a hydroxy acrylonitrile, and a styrene.

Preferably, the adhesive contains a polymer, and the molar weight of the monomer containing carboxyl in the monomers forming the polymer accounts for 10-100% of the molar weight of the total monomers. Further preferably, the molar weight of the monomer containing carboxyl in the monomers forming the polymer accounts for 13˜100% of the molar weight of the total monomers.

Preferably, the glass transition temperature of the adhesive is within the range of −20-120° C. Preferably, the positive electrode or the negative electrode is obtained by coating a slurry containing a positive or negative active material, a conductive agent, an adhesive and a thickening agent on a current collector, and then drying, cold pressing and slicing.

Preferably, the negative active material is selected from at least one of graphite, mesophase carbon microbeads, hard carbon, soft carbon, Li₄Ti₅O₁₂, tin and silicon. In a solid body of the slurry, the mass percentage of the negative active material is not less than 90%.

Preferably, the positive active material is selected from at least one of a lithium cobalt oxide, a lithium manganese oxide and a lithium iron phosphate. In the solid component of the slurry, the mass percentage of the positive active material is not less than 90%.

Preferably, in the solid component of the slurry, the mass percentage of the adhesive is 0.5%-20%. Further preferably, in the solid component of the slurry, the mass percentage of the adhesive is 1%-10%. Further preferably, in the solid component of the slurry, the mass percentage of the adhesive is 1%-5%. Further preferably, in the solid component of the slurry, the mass percentage of the adhesive is 1%-2%.

Those skilled in the art can select the appropriate kind and content of the thickening agent according to actual requirements. Preferably, the thickening agent is selected from a sodium carboxymethyl cellulose and/or a polyacrylamide. Preferably, in the solid body of the slurry, the mass percentage of the thickening agent is 0.8-3%. Further preferably, in the solid body of the slurry, the mass percentage of the thickening agent is 0.8-1.5%.

The current collector is a metal foil, and is preferably a copper foil or an aluminum foil.

Preferably, the separator is a porous polyethylene film (abbreviated as PE separator) and/or a porous polypropylene film (abbreviated as PP separator).

Those skilled in the art can select the appropriate kind and content of the conductive agent according to actual requirements. Preferably, the conductive agent is selected from at least one of conductive carbon black, graphene, and carbon nanotube. Preferably, in the solid body of the slurry, the mass percentage of the conductive agent is 1-5%.

According to another aspect of the present application, a method for preparing the above lithium-ion secondary battery is provided, wherein the method comprises at least the following steps of:

a) Coating a coupling agent on a separator, and drying to obtain a modified separator;

b) Sequentially stacking or winding a positive electrode, the modified separator and a negative electrode, and then hot-press baking so that the coupling agent reacts with the surface of the separator and an adhesive in the positive electrode and/or the negative electrode respectively to form a covalent bond, to obtain a bare cell of the lithium-ion secondary battery;

c) Packaging the bare cell of the lithium-ion secondary battery obtained in Step b), injecting an electrolyte, performing formation,degassing and molding, to obtain the lithium-ion secondary battery.

Preferably, the step of coating the coupling agent on the separator is coating a solution containing the coupling agent on the separator by means of at least one of dipping, spraying and brushing.

Preferably, the solution containing the coupling agent is an aqueous solution, an alcohol solution, a ketone solution or an ester solution with 0.5%-2% by weight of the coupling agent. Further preferably, the solution containing the coupling agent is an aqueous solution and/or an ethanol solution.

Preferably, the coupling agent is coated on the separator in an amount of 0.002-10 g/m². Further preferably, the coupling agent is coated on the separator in an amount of 0.01-3.0 g/m². More preferably, the coupling agent is coated on the separator in an amount of 0.5-1.5 g/m².

Preferably, the adhesive in Step b) contains a polymer which is obtained from acrylate monomers and/or acrylic monomers by an emulsion polymerization method or a solution polymerization method. Further preferably, the molar percentage of the acrylic monomers in all monomers forming the polymer is not less than 13%. More preferably, a lower limit of the molar percentage of the acrylic monomers in all monomers forming the polymer is selected from 20%, 30%, 35% and 50%.

Preferably, the hot-press baking in Step b) is vacuum baking for 4-24 hours under a pressure of 100-150 MPa/m² at a temperature of 80-180° C.

By taking a silane coupling agent as an example, the way of the coupling agent reacting with the surface of the separator and the adhesive in the positive electrode and/or the negative electrode respectively after hot-press baking to form the covalent bond is: a siloxane group in the coupling agent being connected with the separator via a Si—O covalent bond; the amino and/or the epoxy group in the coupling agent being connected with a carboxyl (or an ester group) having a structural unit shown in Formula I in the adhesive via an amido bond and/or an ester bond formed through a dehydration (dealcoholization) reaction and/or a ring-opening reaction.

The beneficial effects of the present application are as below:

(1) improving the energy density and electrical properties of the lithium-ion battery: the adhesive formed by acrylate monomers and/or acrylic monomers has good ionic conductivity, and the separator and an electrode are connected by a covalent bond, and hence no gap will be generated with circulations, thereby reducing the polarization of the lithium-ion secondary battery. Therefore, the lithium-ion secondary battery has a higher energy density, a better rate capability, a better low temperature property and a better cycle life.

(2) improving the safety performance of the lithium-ion battery: since the surface of the separator is treated with the coupling agent which has a better high temperature resistance performance and is connected with an electrode through a covalent bond, the shrinkage of the separator can be suppressed, thereby avoiding fire, explosion and other accidents caused by the short circuit of the electrode due to the shrinkage of the separator.

### SPECIFIC EMBODIMENTS

The invention will be described in details with reference to the drawings and examples.

However, the present application is not limited to these drawings and examples.

The proportions in the examples are all calculated based on parts by weight.

### EXAMPLE 1

(1) Preparation of an Adhesive

300 parts by weight of deionized water and 100 parts by weight of an acrylic monomer were added into a three-neck reaction kettle equipped with a temperature sensor, a nitrogen inlet tube and a stirring blade, and the mixture was stirred uniformly, and then heated to 50° C., 0.02 parts by weight of potassium persulfate-sodium sulfite as an initiator were added and reacted for 2 hours to obtain the polyacrylic acid adhesive, which was denoted as B1, wherein the molecular weight of the polyacrylic acid was 1 million.

(2) Preparation of a Positive Electrode

A positive active material, lithium cobalt oxide (LiCoO₂), the adhesive B1 and conductive carbon black were mixed, and stirred at a high speed to obtain a mixture which was dispersed uniformly and contained the positive active material. In the mixture, the solid component contained 90 wt % of lithium cobalt oxide, 5 wt % of the adhesive B1 and 5 wt % of the conductive carbon black. The mixture was prepared into a slurry of the positive active material by using NMP (N-methylpyrrolidone) as a solvent, and the solid content in the slurry was 75 wt %. The slurry was uniformly coated on both surfaces of an aluminum foil, dried, and compacted by a roller press to obtain a positive electrode, which was denoted as P1.

(3) Preparation of a Negative Electrode

An active material, artificial graphite, the adhesive B1, sodium carboxymethyl cellulose as a thickening agent and the conductive carbon black as a conductive agent were mixed, and stirred at a high speed to obtain a mixture which was dispersed uniformly and contained a negative active material. In the mixture, the solid component contained 95 wt % of the artificial graphite, 1.5 wt % of the sodium carboxymethyl cellulose, 1.5 wt % of the conductive carbon black, and 2 wt % of the adhesive B1. Water was used as a solvent to prepare a slurry of the negative active material, and the solid content in the slurry was 50 wt %. The slurry was uniformly coated on both surfaces of a copper foil, dried, and compacted by the roller press to obtain a negative electrode, which was denoted as N1.

(4) Coating of a Separator

An ethanol solution of aminopropyltriethoxysilane with a concentration of 1.0 wt % was uniformly coated on a porous PE separator of a substrate with a thickness of 7 um by means of spray coating, and roasted at a temperature of 40° C.; after one surface was coated, the other surface was coated, and then was roasted at a temperature of 40° C. to obtain the separator coated with a coupling agent, which was denoted as M1. The coating amount of aminopropyltriethoxysilane on the porous PE separator was 0.5 g/m². Aminopropyl triethoxysilane could be abbreviated as a KH550 silane coupling agent.

(5) Assembly of a Battery

The positive electrode P1, the separator M1 and the negative electrode N1 were wound to form a bare cell. The bare cell was clamped by a glass clamp with a force of 100 MPa/m², roasted in vacuum at a high temperature of 180° C. for 4 hours, and then encapsulated with an Al-plastic film. The electrolyte adopted a lithium hexafluorophosphate electrolyte of 1M, and the solvent was a mixed solvent of ethylene carbonate/dimethyl carbonate/1,2 propylene carbonate at a ratio of 1:1:1 (volume ratio). The battery was encapsulated, formed and aged to obtain a square flexible battery with the length*width*thickness of 32 mm×82 mm×42 mm, which was denoted as C1. The way of the surface of the separator of the prepared battery reacting with an adhesive in the positive electrode and/or the negative electrode to form a covalent bond was: the siloxane group in the coupling agent and the separator were connected via a Si—O covalent bond; the amino group in the coupling agent and the carboxyl group of the structural unit of the adhesive formed an amide bond connection through a dehydration reaction.

### EXAMPLE 2

(1) The Preparation of an Adhesive

4 parts by weight of an emulsifying agent (consisting of 2 parts by weight of sodium dodecyl benzene sulfonate and 2 parts by weight of nonylphenol polyoxyethylene ether) were dissolved in 300 parts by weight of deionized water to obtain a solution containing an emulsifier. The above solution containing the emulsifier, 25 parts by weight of n-butyl acrylate and 75 parts of methacrylic acid were added into a three-neck reaction kettle equipped with a temperature sensor, a nitrogen inlet tube and a stirring blade, and stirred uniformly, and then heated to 80° C.; 3 parts by weight of potassium persulfate as an initiator was added and reacted for 4 hours to obtain a n-butylacrylate-methacrylic acid copolymer adhesive, which was denoted as B2, wherein the molecular weight of the copolymer was 1 million.

(2) Preparation of a Positive Electrode

The preparation steps and ratio of the positive electrode in this example were the same as the positive electrode P1 in Example 1, except the adhesive was replaced with B2, and the obtained positive electrode was denoted as P2.

(3) The Preparation of a Negative Electrode

The preparation steps and ratio of the negative electrode in this example were the same as the negative electrode N1 in Example 1,except the adhesive was replaced with B2, and the obtained positive electrode was denoted as N2.

(4) Coating of a Separator

The steps were the same as those in M1 of Example 1, except that the coating amount of aminopropyltriethoxysilane on a porous PE separator was 1.0 g/m². The obtained separator coated with a coupling agent was denoted as M2.

(5) Assembly of a Battery

The positive electrode P2, the separator M2 and the negative electrode N2 were wound to form a bare cell. The bare cell was clamped by a glass clamp with a force of 110 MPa/m², roasted in vacuum at a high temperature of 150° C. for 8 hours, and then encapsulated with an Al-plastic film. The electrolyte adopted a lithium hexafluorophosphate electrolyte of 1M, and the solvent was a mixed solvent of ethylene carbonate/dimethyl carbonate/1,2 propylene carbonate at a ratio of 1:1:1 (volume ratio). The battery was encapsulated, formed and aged to obtain a square flexible battery with the length*width*thickness of 32 mm×82 mm×42 mm, which was denoted as C2. The way of the surface of the separator of the prepared battery reacting with the adhesive in the positive electrode and/or the negative electrode to form a covalent bond was: the siloxane group in the coupling agent and the separator were connected via a Si—O covalent bond; the amino group in the coupling agent and the ester group and carboxyl group of the structural unit of the adhesive formed an amide bond connection through dealcoholization and dehydration reactions.

### EXAMPLE 3

(1) Preparation of an Adhesive

4 parts by weight of an emulsifying agent (consisting of 2 parts by weight of sodium dodecyl benzene sulfonate and 2 parts by weight of nonylphenol polyoxyethylene ether) were dissolved in 300 parts by weight of deionized water to obtain a solution containing an emulsifier. The above solution containing the emulsifier, 40 parts by weight of methyl acrylate, 30 parts of methyl methacrylate, 30 parts by weight of acrylic acid were added into a three-neck reaction kettle equipped with a temperature sensor, a nitrogen inlet tube and a stirring blade, and stirred uniformly, and then heated to 80° C.; 3 parts by weight of potassium persulfate as an initiator were added and reacted for 4 hours to obtain a methylacrylate-methylmethacrylate-acrylic acid copolymer adhesive, which was denoted as B3, wherein the molecular weight of copolymer was 1 million.

(2) Preparation of a Positive Electrode

The preparation steps and ratio of the positive electrode in this example were the same as the positive electrode P1 in Example 1, except the adhesive was replaced with B3, and the obtained positive electrode was denoted as P3.

(3) Preparation of a Negative Electrode

The preparation steps and ratio of the negative electrode in this example were the same as the negative electrode N1 in Example 1, except the adhesive was replaced with B3, and the obtained positive electrode was denoted as N3.

(4) Coating of a Separator

The steps were the same as those in M1 of Example 1, except that an ethanol solution of (2,3-epoxypropoxy)propyltrimethoxysilane with a concentration of 1.0 wt % was adopted, the coating amount of (2,3-epoxypropoxy)propyltrimethoxysilane on the porous PE separator was 1.5 g/m², and the obtained separator coated with a coupling agent was denoted as M3. (2,3-epoxypropoxy)propyltrimethoxysilane could be abbreviated as a KH560 silane coupling agent.

(5) Assembly of a Battery

The positive electrode P3, the separator M3 and the negative electrode N3 were wound to form a bare cell. The bare cell was clamped by a glass clamp with a force of 130 MPa/m², roasted in vacuum at a high temperature of 120° C. for 20 hours, and then encapsulated with an Al-plastic film. The electrolyte adopted a lithium hexafluorophosphate electrolyte of 1M, and the solvent was a mixed solvent of ethylene carbonate/dimethyl carbonate/1,2 propylene carbonate at a ratio of 1:1:1 (volume ratio). The battery was encapsulated, formed and aged to obtain a square flexible battery with the length*width*thickness of 32 mm×82 mm×42 mm, which was denoted as C3. The way of the surface of the separator of the prepared battery reacting with an adhesive in the positive electrode and/or the negative electrode to form a covalent bond was: the siloxane group in the coupling agent and the separator were connected via a Si—O covalent bond; the epoxy group in the coupling agent and the ester group and carboxyl group of the structural unit of the adhesive formed an ester bond connection through a ring-opening reaction.

### EXAMPLE 4

(1) Preparation of an Adhesive

4 parts by weight of an emulsifying agent (consisting of 2 parts by weight of sodium dodecyl benzene sulfonate and 2 parts by weight of nonylphenol polyoxyethylene ether) were dissolved in 300 parts by weight of deionized water to obtain a solution containing an emulsifier.

The solution containing the emulsifier, 60 parts by weight of octylacrylate, 30 parts of methylmethacrylate, 5 parts by weight of acrylic acid and 5 parts by weight of hydroxyethyl methacrylate were added into a three-neck reaction kettle equipped with a temperature sensor, a nitrogen inlet tube and a stirring blade, and stirred uniformly, and then heated to 80° C.; 3 parts by weight of potassium persulfate as an initiator was added and reacted for 4 hours to obtain an octylacrylate-methylmethacrylate-acrylic acid-hydroxyethyl methacrylate copolymer adhesive, which was denoted as B4, wherein the molecular weight of copolymer was 1 million.

(2) Preparation of a Positive Electrode

The preparation steps and ratio of the positive electrode in this example were the same as those of the positive electrode P1 in Example 1, except that the adhesive was replaced with B4, and the obtained positive electrode was denoted as P4.

(3) Preparation of a Negative Electrode

The preparation steps and ratio of the negative electrode in this example were the same as those of the negative electrode N1 in Example 1, except that the adhesive was replaced with B4, and the obtained positive electrode was denoted as N4.

(4) Coating of a Separator

The steps were the same as those in M1 of Example 1, except that in the adopted ethanol solution containing a coupling agent, the coupling agents were aminopropyltriethoxysilane and (2,3-epoxypropoxy)propyltrimethoxysilane. Wherein, the concentration of the aminopropyltriethoxysilane was 1.0 wt %, and the concentration of (2,3-epoxypropoxy)propyltrimethoxysilane was 1.0 wt %. The coating amount of aminopropyltriethoxysilane and (2,3-epoxypropoxy)propyltrimethoxysilane on the porous PE separator was 0.5 g/m², and the obtained separator coated with the coupling agent was denoted as M4.

(5) Assembly of a Battery

The positive electrode P4, the separator M4 and the negative electrode N4 were wound to form a bare cell. The bare cell was clamped by a glass clamp with a force of 150 mpa/m², roasted in vacuum at a high temperature of 80° C. for 24 hours, and then encapsulated with an Al-plastic film. The electrolyte adopted a lithium hexafluorophosphate electrolyte of 1M, and the solvent was a mixed solvent of ethylene carbonate/dimethyl carbonate/1,2 propylene carbonate at a ratio of 1:1:1 (volume ratio). The battery was encapsulated, formed and aged to obtain a square flexible battery with the length*width*thickness of 32 mm×82 mm×42 mm, which was denoted as C4. The way of the surface of the separator of the prepared battery reacting with the adhesive in the positive electrode and/or the negative electrode to form a covalent bond was: the siloxane group in the coupling agent and the separator were connected via a Si—O covalent bond; the amino group and epoxy group in the coupling agent and the ester group and carboxyl group formed an amide bond connection and an ester bond connection through dealcoholization and dehydration reaction and ring-opening reaction, respectively.

### COMPARATIVE EXAMPLE 1

(1) Preparation of a Positive Electrode

The preparation steps and ratio of the positive electrode in this example were the same as those of the positive electrode P1 in Example 1, except that the adhesive was replaced with polyvinylidene fluoride (PVDF in short), and the obtained positive electrode was denoted as P5.

(2) Preparation of a Negative Electrode

The preparation steps and ratio of the positive electrode in this example were the same as those of the positive electrode P1 in Example 1, except that the adhesive was replaced with styrene Butadiene Rubber (SBR for short), and the obtained positive electrode was denoted as N5.

(3) Assembly of a Battery

The positive electrode P5, a porous PE separator with a thickness of 7 um and the negative electrode N5 were wound to form a bare cell, and then encapsulated with an Al-plastic film. The electrolyte adopted a lithium hexafluorophosphate electrolyte of 1M, and the solvent was a mixed solvent of ethylene carbonate/dimethyl carbonate/1,2 propylene carbonate at a ratio of 1:1:1 (volume ratio). The battery was encapsulated, formed and aged to obtain a square flexible battery with the length*width*thickness of 32 mm×82 mm×42 mm, which was denoted as DC1.

### COMPARATIVE EXAMPLE 2

The positive electrode P1, a porous PE separator with a thickness of 7 um and the negative electrode N1 were wound to form a bare cell, and encapsulated with an Al-plastic film. The electrolyte adopted a lithium hexafluorophosphate electrolyte of 1M, and the solvent was a mixed solvent of ethylene carbonate/dimethyl carbonate/1,2 propylene carbonate at a ratio of 1:1:1 (volume ratio). The battery was encapsulated, formed and aged to obtain a square flexible battery with the length*width*thickness of 32 mm×82 mm×42 mm, which was denoted as DC2.

### COMPARATIVE EXAMPLE 3

The positive electrode P5, a separator M1 and the negative electrode N5 are wound to form a bare cell, and encapsulated with an Al-plastic film. The electrolyte adopted a lithium hexafluorophosphate electrolyte of 1M, and the solvent was a mixed solvent of ethylene carbonate/dimethyl carbonate/1,2 propylene carbonate at a ratio of 1:1:1 (volume ratio). The battery was encapsulated, formed and aged to obtain a square flexible battery with the length*width*thickness of 32 mm×82 mm×42 mm, which was denoted as DC3.

### EXAMPLE 5

### Measurement of the Expansion Rate of a Cell

The expansion rates of the cells in batteries C1˜C4 obtained in examples 1-4 and those of batteries DC1-DC3 obtained in Comparative Examples 1-3 were measured respectively. The measurement method was: measuring the thicknesses of each cell in half-charged state and full-charged state respectively using a thickness gage.

Expansion rate=ratio of (thickness in full-charged state−thickness in half-charged state)/thickness in half-charged state.

20 of the above respective batteries were measured and the results were averaged, see Table 1. From the data in Table 1, the expansion rates of cells DC1-DC3 prepared in Comparative Examples 1-3 when they are firstly fully charged were near 3.0%, however, the expansion rates of cells prepared in Examples 1-4 when they are firstly fully charged did not exceed 1.7%; the expansion rates of batteries C1-C4 all remained below 4.5% even after 500 times of circulations.

### EXAMPLE 6

### Measurement of the Deformation Rate of Batteries

The deformation rates of batteries C1˜C4 obtained in Examples 1-4 and those of batteries DC1˜DC3 obtained in Comparative Examples 1-3 were measured. The measurement method was: measuring the thickness of the lithium-ion secondary batteries in a full-charged state using a thickness gage and a micrometer respectively.

Deformation rate=(the thickness measured by the micrometer−the thickness measured by the thickness gage)/the thickness measured by the thickness gage×100%. It is defined to be “no deformation” if the deformation rate is less than 3%.

20 of the above respective batteries were measured and the results were averaged, see Table 1. From the data in Table 1, the deformation rates of cells DC1-DC3 prepared in Comparative Examples 1-3 when they are firstly fully charged were 2.3-2.7%, however, the deformation rates of cells prepared in Examples 1-4 when they are firstly charged fully were all less than 0.4%, and did not exceed 0.4% even after 500 times of circulations. The deformation rates of batteries prepared in Comparative Examples 1-3 had reached up to 4.8-5.1% after 500 times of circulations.

### EXAMPLE 7

### Measurement of the Capacity Retention Rate of a Lithium-Ion Secondary Battery

The capacity retention rates of batteries C1-C4 obtained in Examples 1-4 and those of batteries DC1-DC3 obtained in Comparative Examples 1-3 were measured. At a normal temperature, the batteries were charged to have the voltage of 4.4V at 0.7 C rate of constant current and then charged to have the current of 0.025 C at a constant voltage of 4.4V; then the batteries were discharged to have a voltage of 3.0V at a constant current of 0.5 C. The above process was one charge-discharge circulation, and this process was repeated for 500 times.

Capacity retention rate in the 500^{th} circulation=the discharge capacity in the 500^{th} circulation/the first discharge capacity×100%.

20 of the above respective batteries were measured and the results were averaged, see Table 1. From the data in Table 1, the capacity retention rates of the lithium-ion secondary battery in Comparative Examples 1-3 after 500 times of circulation were 83-86%, however the capacity retention rates of the lithium-ion secondary battery in Examples 1-4 after 500 times of circulation all were above 90%.

### EXAMPLE 8

### Measurement of the Discharge Rate of a Lithium-Ion Secondary Battery

The discharge rates of batteries C1-C4 obtained in Examples 1-4 and those of batteries DC1-DC3 obtained in Comparative Examples 1-3 were measured. The measurement method was that: at normal temperature, the battery was charged to have a voltage of 4.35V at 0.7 C rate of constant current and then charged to have a current of 0.025 C at a constant voltage of 4.35V; then the battery was discharged to have a voltage of 3.0V at a constant current 0.1 C and a constant current of 2.0 C respectively and the discharge capacities were recorded respectively.

Discharge rate=the discharge capacity at 2.0 C/the discharge capacity at 0.1 C×100%.

20 of the above respective batteries were measured and the results were averaged, see Table 1. From the data in Table 1, for the batteries C1-C4 adopting the technical solution of the present application, due to the function of the conductive ion of the ester group, and as there was not a gap between separators of an electrode, the rates were increased greatly. The discharge rates of the batteries DC1-DC3 obtained in comparative examples 1˜3 were about 90%, while the discharge rates of the batteries C1-C4 were all above 96%.

### EXAMPLE 9

### Measurement of Volumetric Energy Density

The volumetric energy densities of batteries C1-C4 obtained in Examples 1˜4 and those of batteries DC1-DC3 obtained in Comparative Examples 1-3 were measured using the following calculation formula:

Volume energy density=(the first discharge capacity at 0.2 C at 25° C.×voltage)/the volume of a battery.

20 of the above respective batteries were measured and the results were averaged, see Table 1. From the data in Table 1, for the batteries C1-C4 prepared based on the technical solution of the present application, their volume energy densities were all above 630 Wh/L, while the volume energy densities of the batteries DC1-DC3 prepared based on Comparative Examples 1-3 did not exceed 608 Wh/L.

### EXAMPLE 10

### Safety Measurement—Nail

The batteries C1-C4 obtained in Examples 1˜4 and the batteries DC1-DC3 obtained in Comparative Examples 1-3 were subjected to a nail test respectively. The method was: a nail with a diameter of 2 mm˜3 mm was inserted into the center of a lithium-ion secondary battery at a moving speed of 100 mm/s, and the battery is qualified if it neither combusts nor explodes. 20 of the respective batteries were tested and the passing rates thereof were calculated. The results were shown in Table 1. From the data in Table 1, by using the technical solution of the present application, the acupuncture safety of the batteries was increased from 85% to 100%.

### EXAMPLE 11

### Safety Measurement—Crush

The batteries C1-C4 obtained in Examples 1˜4 and the batteries DC1-DC3 obtained in Comparative Examples 1-3 were subjected to a crush test respectively. The method was that: a cell was laterally crushed by the force of 13 KN, if there were neither combustion nor explosion, the battery was qualified. 20 of the respective batteries were tested and passing rates thereof were calculated. The results were shown in Table 1. From the data in Table 1, by using the technical solution of the present application, the extrusion safety of the batteries was increased from 85%-90% to 100%.

| | | | | Test Results of Properties | | | | | | | | |
|---|---|---|---|---|---|---|---|---|---|---|---|---|
| Preparation conditions | | | | Lithium-Ion Secondary Battery | | | | | | | | |
| | Monomers | | The | | Expan- | | Defor- | | Capacity | | | |
| | in an | | Molar | | sion | | mation | | Retention | | | |
| | Adhesive | Coupling | Ratio of | | Rate % | | Rate | | Rate | | | |
| | and the | Agent | Carboxyl | Expan- | (after | | (after | | after | | Passing | Passing |
| | Proportion | Solution | Monomer | sion | 500 | Defor- | 500 | Volu- | 500 | | Rate | Rate |
| | of each | for | in | Rate | Times | mation | Times | metric | times of | | of | of |
| | Monomer | Coating | Adhesive | % | of | Rate | of | Energy | circu- | Rate | Nail | Crush |
| | in Total | Separation | in Total | (100% | Circu- | (100% | Circu- | Density | lation | 2.0C | Test | Test |
| Examples | Monomers | Film | Monomers | SOC) | lation ) | SOC) | lation ) | (wh/L) | (%) | (%) | (%) | (%) |
| Example 1 | Acrylic Acid | Ethanol Solution | 100% | 1.2 | 3.8 | 0.28 | 0.3 | 635 | 92 | 97.0 | 100 | 100 |
| | 100 wt % | of KH550 with a | | | | | | | | | | |
| | | Concentration of | | | | | | | | | | |
| | | 1.00 wt % | | | | | | | | | | |
| Example 2 | Butyl Acrylate | Ethanol Solution | 73% | 1.7 | 4 | 0.33 | 0.4 | 631 | 91 | 97.4 | 100 | 100 |
| | 25 wt % | of KH550 with a | | | | | | | | | | |
| | Methacrylate | Concentration of | | | | | | | | | | |
| | 75 wt % | 1.00 wt % | | | | | | | | | | |
| Example 3 | Methacrylate | Ethanol Solution | 35% | 1.6 | 4 | 0.35 | 0.4 | 639 | 90 | 98.1 | 100 | 100 |
| | 40 wt % | of KH560 with a | | | | | | | | | | |
| | Methyl | Concentration of | | | | | | | | | | |
| | Methacrylate | 1.00 wt % | | | | | | | | | | |
| | 30 wt % | | | | | | | | | | | |
| | Acrylic Acid | | | | | | | | | | | |
| | 30 wt % | | | | | | | | | | | |
| Example 4 | Octyl Acrylate | Ethanol Solution | 13% | 1.3 | 4.3 | 0.36 | 0.4 | 630 | 90 | 96.8 | 100 | 100 |
| | 60 wt % | of KH550 with a | | | | | | | | | | |
| | Methyl | Concentration of | | | | | | | | | | |
| | Methacrylate | 1.00 wt % and | | | | | | | | | | |
| | 30 wt % | Ethanol Solution | | | | | | | | | | |
| | Acrylic Acid | of KH560 with a | | | | | | | | | | |
| | 5 wt % | Concentration of | | | | | | | | | | |
| | Hydroxyethyl | 1.00 wt % | | | | | | | | | | |
| | methacrylate | | | | | | | | | | | |
| | 5 wt % | | | | | | | | | | | |
| Comparative | Adhesive | — | 0% | 3.0 | 5.8 | 2.3 | 4.8 | 603 | 86 | 90.7 | 85 | 90 |
| Example 1 | of Positive | | | | | | | | | | | |
| | Plate: PVDF | | | | | | | | | | | |
| | Adhesive | | | | | | | | | | | |
| | of Negative | | | | | | | | | | | |
| | Plate: SBR | | | | | | | | | | | |
| Comparative | Acrylic Acid | — | 100% | 2.9 | 6.1 | 2.7 | 5.1 | 608 | 85 | 89.9 | 85 | 85 |
| Example 2 | 100 wt % | | | | | | | | | | | |
| Comparative | Adhesive | Ethanol Solution | 0% | 2.7 | 6.0 | 2.4 | 4.9 | 601 | 83 | 90.5 | 85 | 90 |
| Example 3 | of Positive | of KH550 with a | | | | | | | | | | |
| | Plate: PVDF | Concentration of | | | | | | | | | | |
| | Adhesive | 1.00 wt % | | | | | | | | | | |
| | of Negative | | | | | | | | | | | |
| | Plate: SBR | | | | | | | | | | | |

Comparing with the data of Examples 1˜4 in Table 1, it could be seen that: in the monomers of the polymer contained in the formed adhesive, with the increase of the carboxyl content and the molar ratio of a carboxyl monomer in the total monomers, the expansion rate of a lithium-ion secondary battery was decreased, the deformation thereof was increased and the volume energy density thereof was increased.

The above-mentioned are only preferred embodiments of the present application and are not intended to limit the present application. For those skilled in the art, the present application may make various modification and changes. Any modification, equal substitution and improvement made within the spirit and principle of the present application shall be comprised in the protection scope of the present application.

1. A lithium-ion secondary battery, comprising a positive electrode, a negative electrode, a separator and an electrolyte, wherein, the positive electrode and/or the negative electrode contain an adhesive, the separator and the adhesive are connected by a coupling agent with a covalent bond; the coupling agent contains an epoxy group and/or amino group; the adhesive contains a polymer, and the structural formula of at least one of monomers forming the polymer contains a group shown in Formula I: 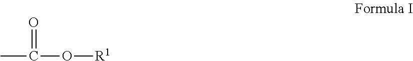
in which, R¹ is hydrogen or R¹ is selected from a hydrocarbyl group having 1 to 20 carbon atoms or R¹ is selected from a group having 1 to 20 carbon atoms and containing at least one of a hydroxyl, a cyano group, a ketone group, an aldehyde group, a phenolic group, and an epoxy group.

2. The lithium-ion secondary battery according to claim 1, wherein, the coupling agent is selected from at least one of a silane coupling agent, a titanate coupling agent, and an aluminate coupling agent.

3. The lithium-ion secondary battery according to claim 1, wherein, the coupling agent is selected from at least one of 2-(3,4-epoxycyclohexyl)ethyltrimethoxysilane, 3-glycidoxypropyltrimethoxysilane, 3-glycidoxypropylmethyldiethoxysilane, 3-glycidoxypropyltriethoxysilane, N-2-(aminoethyl)-3-aminopropylmethyl dimethoxysilane, N-2-(aminoethyl)-3-aminopropyltrimethoxysilane, 3-aminopropyl trimethoxysilane, 3-aminopropyltriethoxysilane, and N-phenyl-3-aminopropyl trimethoxysilane.

4. The lithium-ion secondary battery according to claim 1, wherein, the adhesive contains a polymer, and at least one of the monomers forming the polymer has the structural formula shown in Formula II: 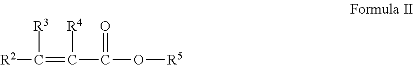
in which, R² is hydrogen or R² is selected from an alkyl having 1 to 20 carbon atoms; R³ is hydrogen or R³ is selected from an alkyl having 1 to 20 carbon atoms; R⁴ is hydrogen or a cyano group or R⁴ is selected from an alkyl having 1 to 20 carbon atoms; R⁵ is hydrogen or R⁵ is selected from an alkyl having 1 to 20 carbon atoms or R⁵ is selected from a group having 1 to 20 carbon atoms and containing at least one of a hydroxyl group, an amino group and an epoxy group.

5. The lithium-ion secondary battery according to claim 4, wherein, R⁵ in Formula II is hydrogen.

6. The lithium-ion secondary battery according to claim 4, wherein, the monomer with the structural formula shown in Formula II is selected from at least one of an acrylic acid, a methacrylic acid, a methylacrylate, a methylmethacrylate , an ethylacrylate, an ethyl methacrylate, a n-butylacrylate, an octylacrylate, a decylacrylate, a laurylacrylate, an isopropylacrylate, a butylmethacrylate, a hydroxymethylmethacrylate, a hydroxyethyl methacrylate, a hydroxypropylmethacrylate, a hydroxybutylmethacrylate, a hydroxypropyl acrylate, a glycoldimethacrylate, a dodecylmethacrylate, a glycidylmethacrylate, an aminoethylacrylate, a butylcyanoacrylate, a hexylcyanoacrylate, and a heptyl cyanoacrylate.

7. A method for preparing the lithium-ion secondary battery according to claim 1, comprising the following steps of:
a) Coating a coupling agent on a separator, and drying to obtain a modified separator;
b) Sequentially stacking or winding a positive electrode, the modified separator and a negative electrode, and then hot-press baking so that the coupling agent reacts with the surface of the separator and an adhesive in the positive electrode and/or the negative electrode respectively to form a covalent bond, to obtain a bare cell of the lithium-ion secondary battery;
c) Packaging the bare cell of the lithium-ion secondary battery obtained in Step b), injecting an electrolyte, performing formation,degassing and molding, to obtain the lithium-ion secondary battery.

8. The method according to claim 7, wherein, the step of coating the coupling agent on the separator in step a) is coating a solution containing the coupling agent on the separator by means of at least one of dipping, spraying and brushing.

9. The method according to claim 7, wherein, the adhesive in Step b) contains a polymer which is obtained from acrylate monomers and/or acrylic monomers by polymerization.

10. The method according to claim 7, wherein, the hot-press baking in Step b) is vacuum baking for 4-24 hours under a pressure of 100-150 MPa/m² at a temperature of 80-180° C.
